(19) United States
(12) Patent Application Publication
(10) Pub. No.: US 2026/0326040 A1
(43) Pub. Date: Oct. 22, 2026

(54) MULTIFUNCTIONAL HALLOYSITE-BASED CERAMIC MEMBRANE FOR WATER TREATMENT APPLICATIONS

(71) Applicant: HAMAD BIN KHALIFA UNIVERSITY, Doha (QA)

(72) Inventors: Dema A. ALMASRI, Doha (QA); Viktor Kochkodan, Doha (QA); Jenny Lawler, Doha (QA)

(21) Appl. No.: 19/099,607

(22) PCT Filed: Aug. 4, 2023
(86) PCT No.: PCT/QA2023/050013

§ 371 Date: Jan. 29, 2025

Related U.S. Application Data
(60) Provisional application No. 63/395,473, filed on Aug. 5, 2022.

(51) Int. Cl. B01D 67/00; B01D 69/02; B01D 71/02; C04B 33/04; C04B 33/13; C04B 33/32; C04B 38/00; C04B 38/06

(52) U.S. Cl. CPC B01D 67/00411; B01D 67/00412; B01D 69/02; B01D 71/025; C04B 33/04; C04B 33/131; C04B 33/32; C04B 38/0054; C04B 38/0675; B01D 2323/18; B01D 2325/02833; B01D 2325/04; C04B 2235/3217; C04B 2235/5284; C04B 2235/95

(57) ABSTRACT

A multifunctional clay based ceramic membrane includes halloysite nanotube (HNT) at a first weight percent, alumina at a second weight percent, and a pore forming agent at a third weight percent. The first weight percent is greater than the second weight percent. The second weight percent is greater than the third weight percent.

### CROSS-REFERENCE TO RELATED APPLICATION

The present application claims priority to U.S. Provisional Application No. 63/395,473 filed Aug. 5, 2022, and entitled “MULTIFUNCTIONAL HALLOYSITE-BASED CERAMIC MEMBRANE FOR WATER TREATMENT APPLICATIONS,” the disclosure of which is incorporated by reference herein in its entirety.

### BACKGROUND

Currently, polymeric membranes dominate the commercial membrane market due to their relatively easier large-scale production as well as the well control of pore size. However, polymeric membranes are sensitive for harsh feed water conditions (pH, temperature), not resistance for organic solvents, prone to fouling due to the hydrophobic nature of the common polymer materials, and their non-biodegradable nature is a concern in terms of long-term environmental pollution. Ceramic membranes have entered the commercial market over the past decades to resolve these issues, but currently available ceramic membranes, such as the ones fabricated from aluminum oxide (Al₂O₃), titanium dioxide (TiO₂), and zirconium dioxide (ZrO₂), are more costly than polymeric membranes. Furthermore, to date, nanofiltration ceramic membranes are very rare due to the difficulty in adjusting and maintaining the small pore size.

### SUMMARY

The present disclosure generally relates to a multifunctional clay-based ceramic membrane and a method of manufacturing the same.

In light of the present disclosure, and without limiting the scope of the disclosure in any way, in an aspect of the present disclosure, which may be combined with any other aspect listed herein unless specified otherwise, a multifunctional clay-based ceramic membrane is provided. The multifunctional clay-based ceramic membrane may include halloysite nanotube (HNT) at a first weight percent, alumina at a second weight percent, and a pore-forming agent at a third weight percent. The first weight percent is greater than the second weight percent.

In light of the present disclosure, and without limiting the scope of the disclosure in any way, in an aspect of the present disclosure, which may be combined with any other aspect listed herein unless specified otherwise, a method for manufacturing a multifunctional clay-based ceramic membrane is provided. The method may include mixing HNT at a first weight percent, alumina at a second weight percent, and a pore-forming agent at a third weight percent to form a HNT-based powder mixture, dry-pressing the HNT-based powder mixture, and heating the dry-pressed HNT-based powder mixture at a first temperature. The first weight percent is greater than the second weight percent.

Additional features and advantages of the disclosed systems and methods are described in, and will be apparent from, the following Detailed Description and the Figures.

### BRIEF DESCRIPTION OF THE FIGURES

FIG. 1 is a flowchart illustrating an example method for manufacturing a multifunctional clay-based ceramic membrane according to an example of the present disclosure.

FIG. 2 shows dry-pressed HNT-based powder mixtures according to an example of the present disclosure.

FIG. 3 is a graph showing an example temperature and time for a sintering process according to an example of the present disclosure.

FIG. 4 is a graph showing a pure water flux of an example multifunctional clay-based ceramic membrane at different applied pressures.

FIG. 5 shows a contact angle measurement using water on the surface of an example multifunctional clay-based ceramic membrane.

FIGS. 6A and 6B are graphs showing results of an anti-fouling test using bovine serum albumin (BSA) for an example multifunctional clay-based ceramic membrane.

FIGS. 7A and 7B are SEM images of the surface and cross-section area of an example multifunctional clay-based ceramic membrane.

FIG. 8 is an SEM-EDS elemental mapping of the surface of an example multifunctional clay-based ceramic membrane depicting the presence and distribution of Al, Si, and O.

### DETAILED DESCRIPTION OF EXAMPLE EMBODIMENTS

The present disclosure generally relates to a multifunctional clay-based ceramic membrane that is made with a mixture of halloysite clay, alumina, and a pore-forming agent (e.g., starch).

Water is an invaluable asset and, specifically in arid regions, lack of water resources is a security issue. However, this is not limited to arid climates. The effects of climate change currently being witnessed worldwide globalize the water scarcity and security dilemma. Consequently, countries all over the world are shifting their focus to sustainable approaches and adopting strict measures on wastewater treatment and its reuse as an alternative water source in various industrial, household, and agricultural applications. Depending on the source, wastewaters may contain different pollutants, including heavy metal ions, oil/grease, organic compounds, and other toxic materials, that deem them unsuitable for direct reuse. Furthermore, treated wastewaters may contain residual amounts of harmful contaminants that hamper water recycling/reuse. Hence, innovative and cost-effective technologies for the treatment of water for suitable applications may be needed.

Over the past decade, membrane-based technologies based on employing of polymeric and ceramic membranes have become some of the most promising and applied water treatment methods. Micro and ultrafiltration ceramic membranes are currently available in the market; usually, these are fabricated from Al₂O₃, TiO₂, and ZrO₂ materials and are more costly than polymeric membranes. Furthermore, to date, nanofiltration ceramic membranes are very rare due to the difficulty in adjusting and maintaining the small pore size.

Ceramic membranes can be used at harsh feed water conditions (pH, temperature, salt content, fouling potential) and regenerated by thermal treatment as compared to polymeric membranes. Aspects of the present disclosure may provide an efficient clay-based ceramic membrane prototype to treat various water types. While polymeric membranes currently dominate the market due to their relatively lower cost when compared to ceramic membranes, in some examples, the ceramic membranes according to the present disclosure may be lower in cost than the commercially available membranes.

Aspects of the present disclosure may provide formulations for the fabrication of multifunctional clay-based ceramic membranes that are durable, cost-effective, and efficient for water treatment. The ceramic membrane may be made with a mixture of halloysite clay, alumina, and a pore-forming agent (e.g., starch).

In some examples, the multifunctional clay-based ceramic membrane may include HNT at a first weight percent, Al₂O₃ at a second weight percent, and a pore-forming agent at a third weight percent. The first weight percent may be greater than the second weight percent. The second weight percent may be greater than the third weight percent.

In some examples, the first weight percent of the HNT may be in a range of about 55 wt. % to about 65 wt. %. For example, the first weight percent of the HNT may be in a range of about 55 wt. % to about 58 wt. %, about 58 wt. % to about 62 wt. %, or about 62 wt. % to about 65 wt. %. In other examples, the first weight percent of the HNT may have any other suitable value.

In some examples, the second weight percent of the alumina may be in a range of about 20 wt. % to about 30 wt. %. For example, the second weight percent of the alumina may be in a range of about 20 wt. % to about 23 wt. %, about 23 wt. % to about 27 wt. %, or about 27 wt. % to about 30 wt. %. In other examples, the second weight percent of the alumina may have any other suitable value.

In some examples, the third weight percent of the pore forming agent may be in a range of about 10 wt. % to about 20 wt. %. For example, the third weight percent of the pore-forming agent may be in a range of about 10 wt. % to about 13 wt. %, about 13 wt. % to about 17 wt. %, or about 17 wt. % to about 20 wt. %. In other examples, the third weight percent of the pore-forming agent may have any other suitable value.

In some examples, the pore-forming agent may be or include starch. In other examples, the pore-forming agent may be or include any other suitable pore-forming agent (e.g., dextran, polyvinyl alcohol, carbon powder).

In some examples, a pore size of the multifunctional clay-based ceramic membrane according to the present disclosure may be in a range of about 40 nm to about 50 nm. For example, the pore size of the multifunctional clay-based ceramic membrane may be in a range of about 40 nm to about 43 nm, about 43 nm to about 47 nm, or about 47 nm to about 50 nm.

In some examples, a porosity of the multifunctional clay-based ceramic membrane according to the present disclosure may be in a range of about 30% to about 40%. For example, the porosity of the multifunctional clay-based ceramic membrane may be in a range of about 30% to about 34%, about 34% to about 37%, or about 37% to about 40%.

In some examples, a thickness of the multifunctional clay-based ceramic membrane according to the present disclosure may be in a range of about 0.3 mm to about 0 1.0 mm. For example, the thickness of the multifunctional clay-based ceramic membrane may be in a range of about 0.3 mm to about 0.5 mm, about 0.5 mm to about 0.8 mm, about 0.8 mm to about 1.0 mm.

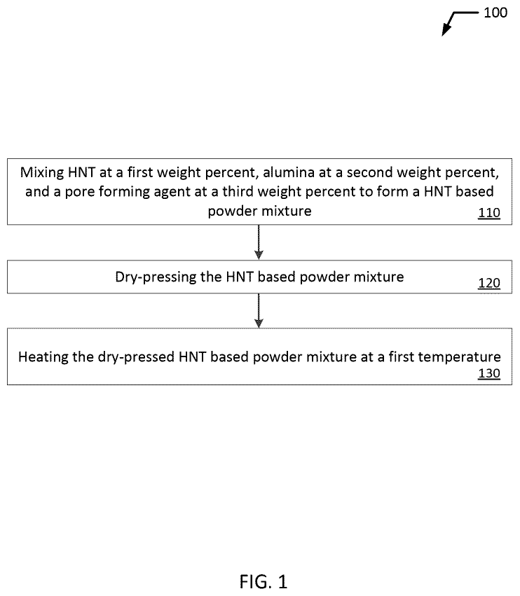

FIG. 1 is a flowchart illustrating an example method 100 for manufacturing a multifunctional clay-based ceramic membrane according to an example of the present disclosure. Although the example method 100 is described with reference to the flowchart illustrated in FIG. 1, it will be appreciated that many other methods of performing the acts associated with the method may be used. For example, the order of some of the blocks may be changed, certain blocks may be combined with other blocks, and some of the blocks described are optional.

In the illustrated example, HNT at a first weight percent, alumina at a second weight percent, and a pore-forming agent at a third weight percent may be mixed to form a HNT-based powder mixture (block 110). The first weight percent may be greater than the second weight percent. The second weight percent may be greater than the third weight percent.

In some examples, the first weight percent of the HNT may be in a range of about 55 wt. % to about 65 wt. %. The second weight percent of the alumina may be in a range of about 20 wt. % to about 30 wt. %. The third weight percent of the pore-forming agent may be in a range of about 10 wt. % to about 20 wt. %. The pore-forming agent may be or include starch and/or any other suitable pore-forming agent.

Then, the HNT-based powder mixture may be dry-pressed (block 120). For example, the HNT-based powder mixture may be pressed in pellets having a predetermined diameter using a dry die press. The predetermined diameter may be in a range of about 10 mm to about 50 mm. The HNT-based powder mixture may be pressed at a predetermined weight for a predetermined period of time. The predetermined weight may be in a range of about 5 metric tons to about 10 metric tons. The predetermined period of time may include about 2 minutes to about 5 minutes.

In some examples, prior to the dry-pressing step, the HNT-based powder mixture may be ball milled at a predetermined speed for a predetermined period of time. The predetermined speed may be in a range of about 50 rpm to about 200 rpm. The predetermined period of time may be in a range of about 2 hours to about 6 hours.

Then, the dry-pressed HNT-based powder mixture may be heated at a first temperature (block 130). For example, the dry-pressed HNT-based powder mixture may be sintered to prevent a crack from forming, for example, due to phase changes and changes in the atomic level as well as membrane shrinkage during the sintering process. In some examples, the first temperature may be in a range of about 1,000 °C to about 1,200 °C. For example, the first temperature may be in a range of about 1,000 °C to about 1,070 °C, about 1,070 °C to about 1,130 °C, or about 1,130 °C to about 1,200 °C. The amount of time for the heat treatment may be in a range of about 5 minutes to about 60 minutes, for example, about 5 minutes to about 20 minutes, about 20 minutes to about 40 minutes, about 40 minutes to about 60 minutes, less than about 60 minutes, or less than about 30 minutes.

In some examples, the method 100 may further include polishing the heated HNT-based powder mixture such that the heated HNT-based powder mixture has a thickness in a range of about 0.3 mm to about 1 mm. For example, the polished HNT-based powder mixture may have a thickness in a range of about 0.3 mm to about 0.4 mm, about 0.4 mm to about 0.6 mm, about 0.6 mm to about 0.7 mm, or about 0.7 mm to about 1 mm.

### EXAMPLES

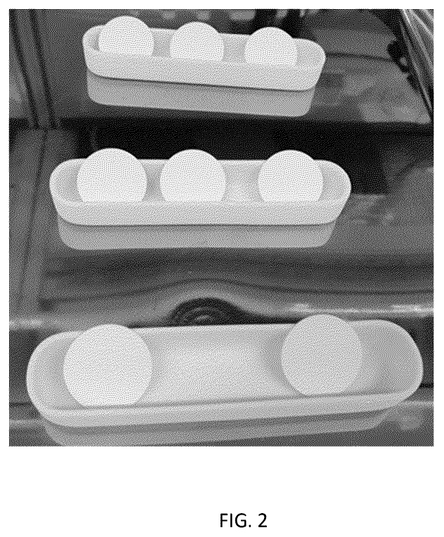

An example multifunctional clay-based ceramic membrane was prepared from a mixture of HNT, alumina, and starch. Different compositions of a slurry mixture—HNTs (30-70 wt. %), alumina (20-80 wt. %), and starch (5-30 wt. %)—were tested, for example, during/before the membrane sintering stage. Based on the performed screening, an example membrane was prepared from a combination of HNT (61 wt. %), alumina (25 wt. %), and starch (14 wt. %), which was found to be a proper amount to produce membranes that were easily die-pressed and did not show cracks on the surface or cross-section. The powders of HNT (61 wt. %), alumina (25 wt. %), and starch (14 wt. %) were ball milled at 100 rpm for 4 hours. The membranes were pressed in 25 mm diameter pellets using a dry die press by adding 1000 mg in the die press set. The membranes were pressed at 8 metric tons for a period of 3.5 minutes, which forms dry-pressed HNT-based powder mixtures as shown in FIG. 2. After the dry-pressing step, the HNT-based powder mixtures may have a disc shape as shown in FIG. 2.

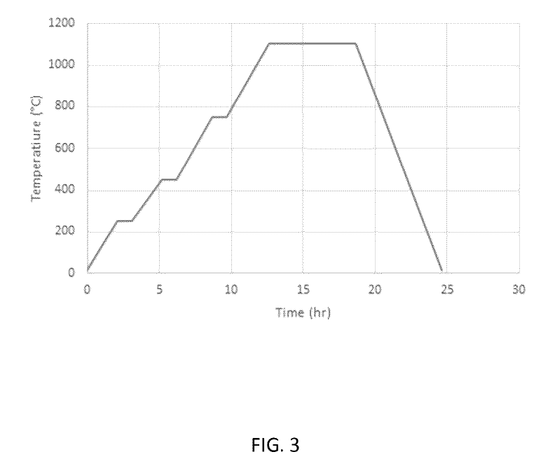

Then, the dry-pressed HNT-based powder mixtures were sintered in a furnace at 1,100 °C, for example, to burn off the carbon content to form the pores. FIG. 3 is a graph showing the temperature and time for the sintering process. As shown in FIG. 3, the dry-pressed HNT-based powder mixtures may be placed in the furnace and go through a thermal cycle. For example, after the dry-pressed HNT-based powder mixtures are placed in the furnace, the temperature of the furnace may be increased from the room temperature to 1,100 °C, for example, within about 12 to 13 minutes, and the temperature is maintained at 1,100 °C, for example, for about 5 to 6 minutes, and then the temperature may be decreased from 1,100 °C to the room temperature, for example, within about 7 to 8 minutes. The total sintering process may take about 25 minutes. Not wishing to be bound by theory, it is believed that the sintering process may prevent cracks from forming due to phase changes and membrane shrinkage, during the sintering process. Then, the heat-treated HNT-based powder mixtures were polished to have a thickness of 0.5 mm.

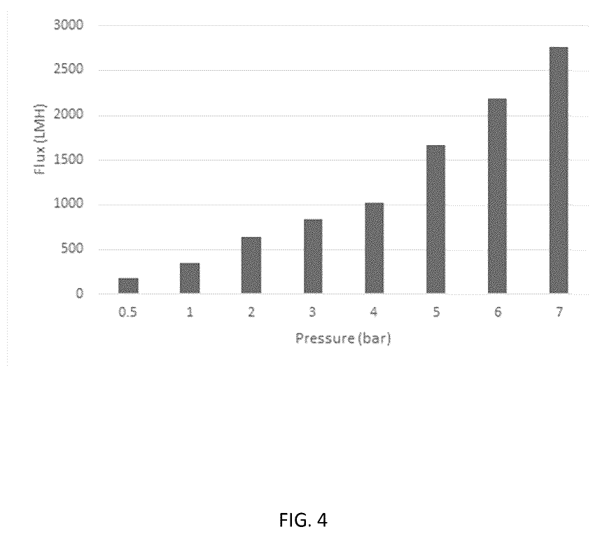

The membrane performance of the prepared multifunctional clay-based ceramic membrane that was manufactured according to the above-discussed process was tested. FIG. 4 is a graph showing the pure water flux of the prepared multifunctional clay-based ceramic membrane at different applied pressures. As shown in FIG. 4, the multifunctional clay-based ceramic membrane prepared according to an example of the present disclosure showed a membrane flux that is significantly high, up to 2500-3000 L/MH.

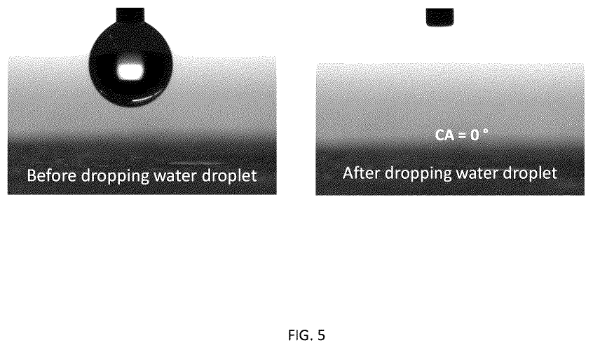

As shown in FIG. 5, the contact angle of the prepared multifunctional clay-based ceramic membrane was also measured. The contact angle measurement of the multifunctional clay-based ceramic membrane shows that the membrane is superhydrophilic with a contact angle of 0°. This is a very attractive feature for the membrane, and the high flux of the prepared multifunctional clay-based ceramic membrane could be attributed to the superhydrophilic membrane property.

The pore size of the prepared multifunctional clay-based ceramic membrane was measured using a mercury porosimeter and was measured to be about 44 nm, while the porosity was about 33%.

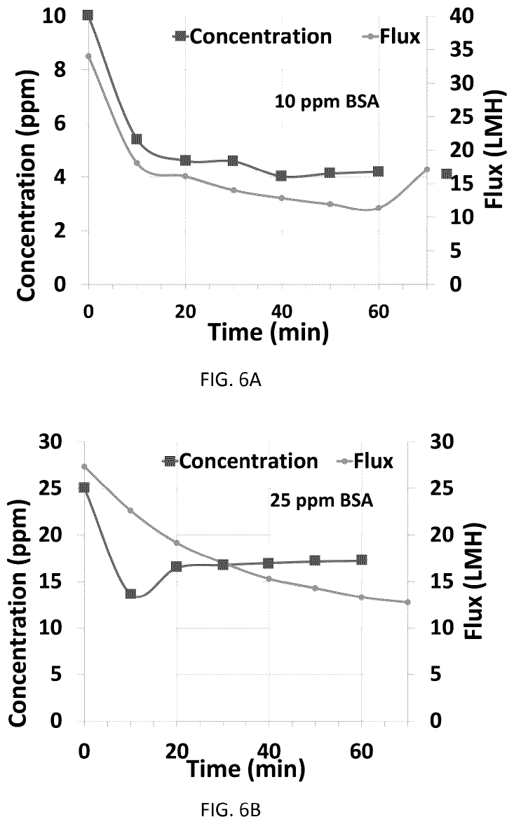

The prepared multifunctional clay-based ceramic membrane was further tested with bovine serum albumin (BSA), a common substance used to test the rejection performance and anti-fouling properties of the membrane. As shown in FIGS. 6A and 6B, the results showed nearly 60% removal achieved after 40 min at 10 ppm initial BSA and 50% removal at 25 ppm initial BSA solution. The membrane flux also decreased when tested with the BSA solution. In particular, the flux decreased rapidly especially in the first 10 minutes. Post-experiment flux with pure water was significantly higher than with the BSA solution. Recoverable flux due to inherent washing may indicate reversible fouling.

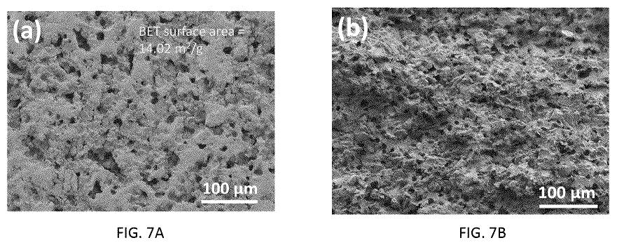

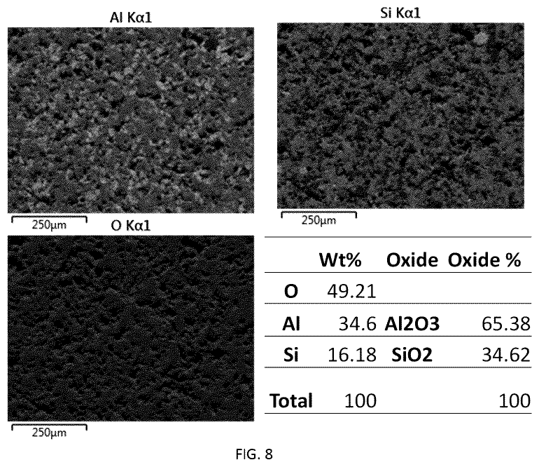

FIGS. 7A and 7B show SEM images of the surface and a cross-section area of the prepared multifunctional clay-based ceramic membrane. FIG. 8 is an SEM-EDS elemental mapping of the surface of the prepared multifunctional clay-based ceramic membrane depicting the presence and distribution of Al, Si, and O. The table in FIG. 8 provides the quantification of the elements as well as the oxides. These images show that the prepared multifunctional clay-based ceramic membrane is a dense membrane with surface pores on the surface and in the cross-section.

### Embodiments

Various aspects of the subject matter described herein are set out in the following numbered embodiments:

Embodiment 1. A multifunctional clay based ceramic membrane comprises halloysite nanotube (HNT) at a first weight percent; alumina at a second weight percent; and a pore forming agent at a third weight percent, wherein the first weight percent is greater than the second weight percent.

Embodiment 2. The multifunctional clay based ceramic membrane of embodiment 1, wherein the second weight percent is greater than the third weight percent.

Embodiment 3. The multifunctional clay based ceramic membrane of any one of embodiments 1 and 2, wherein the first weight percent of the HNT is in a range of about 55 wt. % to about 65 wt. %.

Embodiment 4. The multifunctional clay based ceramic membrane of any one of embodiments 1-3, wherein the second weight percent of the alumina is in a range of about 20 wt. % to about 30 wt. %.

Embodiment 5. The multifunctional clay based ceramic membrane of any one of embodiments 1-4, wherein the third weight percent of the pore forming agent is in a range of about 10 wt. % to about 20 wt. %.

Embodiment 6. The multifunctional clay based ceramic membrane of any one of embodiments 1-5, wherein the pore-forming agent comprises starch.

Embodiment 7. The multifunctional clay based ceramic membrane of any one of embodiments 1-6, wherein a pore size of the membrane is in a range of about 40 nm to about 50 nm.

Embodiment 8. The multifunctional clay based ceramic membrane of any one of embodiments 1-7, wherein a porosity of the membrane is in a range of about 30% to about 40%.

Embodiment 9. The multifunctional clay based ceramic membrane of any one of embodiments 1-8, wherein a thickness of the membrane is in a range of about 0.3 mm to about 1 mm.

Embodiment 10. A multifunctional clay based ceramic membrane comprises halloysite nanotube (HNT) at a first weight percent; alumina at a second weight percent; and starch (or a suitable pore forming agent) at a third weight percent, wherein the first weight percent is greater than the second weight percent, and wherein the second weight percent is greater than the third weight percent.

Embodiment 11. A method of manufacturing a multifunctional clay based ceramic membrane, the method comprises: mixing halloysite nanotube (HNT) at a first weight percent, alumina at a second weight percent, and a pore forming agent at a third weight percent to form a HNT based powder mixture, wherein the first weight percent is greater than the second weight percent; dry-pressing the HNT based powder mixture; and heating the dry-pressed HNT based powder mixture at a first temperature.

Embodiment 12. The method of embodiment 11, further comprising polishing the heated HNT based powder mixture such that the heated HNT based powder mixture has a thickness in a range of about 0.3 mm to about 1 mm.

Embodiment 13. The method of any one of embodiments 11-12, wherein the first temperature is in a range of about 1,000 °C to about 1,200 °C.

Embodiment 14. The method of any one of embodiments 11-13, wherein the second weight percent is greater than the third weight percent.

Embodiment 15. The method of any one of embodiments 11-14, wherein the first weight percent of the HNT is in a range of about 55 wt. % to about 65 wt. %.

Embodiment 16. The method of any one of embodiments 11-15, wherein the second weight percent of the alumina is in a range of about 20 wt. % to about 30 wt. %.

Embodiment 17. The method of any one of embodiments 11-16, wherein the third weight percent of the pore forming agent is in a range of about 10 wt. % to about 20 wt. %.

Embodiment 18. The method of any one of embodiments 11-17, wherein the pore forming agent comprises starch.

Embodiment 19. The method of any one of embodiments 11-18, wherein a pore size of the membrane is in a range of about 40 nm to about 50 nm.

Embodiment 20. The method of any one of embodiments 11-19, wherein a porosity of the membrane is in a range of about 30% to about 40%.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. A multifunctional clay based ceramic membrane comprising:
halloysite nanotube (HNT) at a first weight percent;
alumina at a second weight percent; and
a pore forming agent at a third weight percent,
wherein the first weight percent is greater than the second weight percent.

2. The multifunctional clay based ceramic membrane of claim 1, wherein the second weight percent is greater than the third weight percent.

3. The multifunctional clay based ceramic membrane of claim 1, wherein the first weight percent of the HNT is in a range of about 55 wt. % to about 65 wt. %.

4. The multifunctional clay based ceramic membrane of claim 1, wherein the second weight percent of the alumina is in a range of about 20 wt. % to about 30 wt. %.

5. The multifunctional clay based ceramic membrane of claim 1, wherein the third weight percent of the pore forming agent is in a range of about 10 wt. % to about 20 wt. %.

6. The multifunctional clay based ceramic membrane of claim 1, wherein the pore forming agent comprises starch.

7. The multifunctional clay based ceramic membrane of claim 1, wherein a pore size of the membrane is in a range of about 40 nm to about 50 nm.

8. The multifunctional clay based ceramic membrane of claim 1, wherein a porosity of the membrane is in a range of about 30% to about 40%.

9. The multifunctional clay based ceramic membrane of claim 1, wherein a thickness of the membrane is in a range of about 0.3 mm to about 1 mm.

10. A multifunctional clay based ceramic membrane comprising:
halloysite nanotube (HNT) at a first weight percent;
alumina at a second weight percent; and
starch at a third weight percent,
wherein the first weight percent is greater than the second weight percent, and
wherein the second weight percent is greater than the third weight percent.

11. A method of manufacturing a multifunctional clay based ceramic membrane, the method comprising:
mixing halloysite nanotube (HNT) at a first weight percent, alumina at a second weight percent, and a pore forming agent at a third weight percent to form a HNT based powder mixture, wherein the first weight percent is greater than the second weight percent;
dry-pressing the HNT based powder mixture; and
heating the dry-pressed HNT based powder mixture at a first temperature.

12. The method of claim 11, further comprising polishing the heated HNT based powder mixture such that the heated HNT based powder mixture has a thickness in a range of about 0.3 mm to about 1 mm.

13. The method of claim 11, wherein the first temperature is in a range of about 1,000 °C to about 1,200 °C.

14. The method of claim 11, wherein the second weight percent is greater than the third weight percent.

15. The method of claim 11, wherein the first weight percent of the HNT is in a range of about 55 wt. % to about 65 wt. %.

16. The method of claim 11, wherein the second weight percent of the alumina is in a range of about 20 wt. % to about 30 wt. %.

17. The method of claim 11, wherein the third weight percent of the pore forming agent is in a range of about 10 wt. % to about 20 wt. %.

18. The method of claim 11, wherein the pore forming agent comprises starch.

19. The method of claim 11, wherein a pore size of the membrane is in a range of about 40 nm to about 50 nm.

20. The method of claim 11, wherein a porosity of the membrane is in a range of about 30% to about 40%.
